(19) United States
(12) Patent Application Publication
(10) Pub. No.: US 2013/0344840 A1
(43) Pub. Date: Dec. 26, 2013

(54) GEO-TARGETED ALERTING BASED ON POWER CONTOUR

(71) Applicant: TeleCommunication Systems, Inc., Annapolis, MD (US)

(72) Inventor: Mark A. Titus, Annapolis, MD (US)

(21) Appl. No.: 13/923,654

(22) Filed: Jun. 21, 2013

Related U.S. Application Data
(60) Provisional application No. 61/662,589, filed on Jun. 21, 2012.
(60) Provisional application No. 61/697,476, filed on Sep. 6, 2012.

(51) Int. Cl. H04W 4/22

(52) U.S. Cl. CPC H04W 4/22
USPC 455/404.1

(57) ABSTRACT

Enhanced cell site database information and a spatial geotargeting method that considers radio frequency power contours emitted by cell sites, for the improved accuracy of geotargeted alerting. A geotargeted alert is broadcast to all cell sites with a RF power contour that overlaps an alert area defined for the alert. Targeted cell sites receive the alert and broadcast the alert to subscriber devices located in their coverage area. An RF propagation model computes an RF power contour for a given cell site based on cell site attribute data obtained from a commercial mobile service provider. Cell site attribute data and cell site power contour data is stored in a GIS relational database during system provisioning. When an alert is received, a mobile alerting system performs a spatial query on the relational database to determine which cell sites have a power contour that overlaps an alert area defined for the alert.

The present application claims priority from U.S. Provisional No. 61/662,589, entitled “Geo-Targeted Alerting Based on Received Power Levels”, filed Jun. 21, 2012; and from U.S. Provisional No. 61/697,476, entitled “Geo-Targeted Alerting Based on Received Power Levels”, filed Sep. 5, 2012, the entirety of both of which being expressly incorporated herein by reference.

### BACKGROUND OF THE INVENTION

1. Field of the Invention

This invention relates generally to elements of mobile messaging using GIS mapping information to improve the granularity and accuracy of delivering alert information to a designated geographic area.

2. Background of Related Art

The US Department of Homeland Security (DHS) is seeking ways to improve the accuracy of Commercial Mobile Alert System (CMAS) alerting. A Commercial Mobile Alert System (CMAS) is an alerting technology that allows commercial mobile service providers (CMSP) to send geo-targeted alert messages (similar to text messages) to subscriber devices. Geo-targeted alert messages alert subscribers to potentially dangerous events occurring in their area.

Conventional mobile alerting systems use cell towers to geographically target alerts to subscriber devices.

FIG. 7 depicts a conventional method used to implement geotargeted alerting.

As depicted in step 1, an alert is generated by an authorized government agency 800 and transmitted to a mobile alerting system 810. Each alert indicates one or more alert areas, i.e., geographic areas to which alert information pertains.

As shown in step 2, the mobile alerting system 810 authorizes and processes the received alert and then forwards the alert to participating cell sites 820a-820c located within the one or more indicated alert areas.

In step 3, participating cell sites 820a-820c receive the geotargeted alert and broadcast the alert to subscriber devices 830a-830c located in their coverage area.

An alert area is conventionally defined using a federal information processing standard (FIPS) code. A federal information processing standard (FIPS) code is a standardized numeric code that uniquely identifies a political geographic boundary, e.g., a state, a county, etc. A default alert area mandated for use within the commercial mobile alerting system (CMAS) is a county wide geographic alert area, as defined by a FIPS county code.

Conventional mobile alerting systems broadcast an alert to all cell sites located in an alert area defined therein. Conventional mobile alerting systems rely on database queries/lookups to identify a location of a cell site and a FIPS code defined at that cell site location.

Geotargeted alerting may be implemented via use of a simple cell site database table. Each record in a cell site database table typically includes a cell site identifier, a cell site location, and a FIPS code defined at that cell site location. Commercial off-the-shelf methods and standard government data sets (e.g., zip code data sets, county definition data sets, etc.) may be used to populate a cell site database table. For example, a commercial, off-the-shelf reverse geocoding method (i.e. a method that determines a civic address based on a set of provided location coordinates (lat/lon)) may be used to determine a civic address for a given cell site. A civic address obtained via a reverse geocoding method includes a zip code. Since all zip codes are unique and fully contained within a county political boundary, and since each FIPS code defines an area containing one or more zip codes, a zip code may be used to lookup a FIPS code defined at a particular cell site (via an association lookup on data published by the U.S. Census Bureau).

Conventional alerting technology is limited to geographic targeting methods based purely on address information. Unfortunately, relying solely on address information to target alerts can result in undesired gaps in cell broadcast areas. For example, in accordance with existing technology, a subscriber device located in an alert area does not receive an alert notification when that subscriber device is receiving service from a cell site located outside the alert area (e.g. a cell site located in a neighboring county and therefore assigned a different FIPS code).

### BRIEF DESCRIPTION OF THE DRAWINGS

Features and advantages of the present invention will become apparent to those skilled in the art from the following description with reference to the drawings, in which:

FIG. 1 depicts an exemplary alert area, as defined by a FIPS county code.

FIG. 2 depicts a point in polygon approach proposed for geotargeted alerting.

FIG. 3 depicts exemplary geographic coverage areas modeled by cell site propagation, in accordance with the principles of the present invention.

FIG. 4 depicts exemplary alert system provisioning for geotargeted alerting based on received power levels, in accordance with the principles of the present invention.

FIG. 5 depicts an exemplary process for geographically targeting an alert based on received power levels, in accordance with the principles of the present invention.

FIG. 6 depicts an illustrative alert message generated by a government agency, in accordance with the principles of the present invention.

FIG. 7 depicts a conventional method used to implement geotargeted alerting.

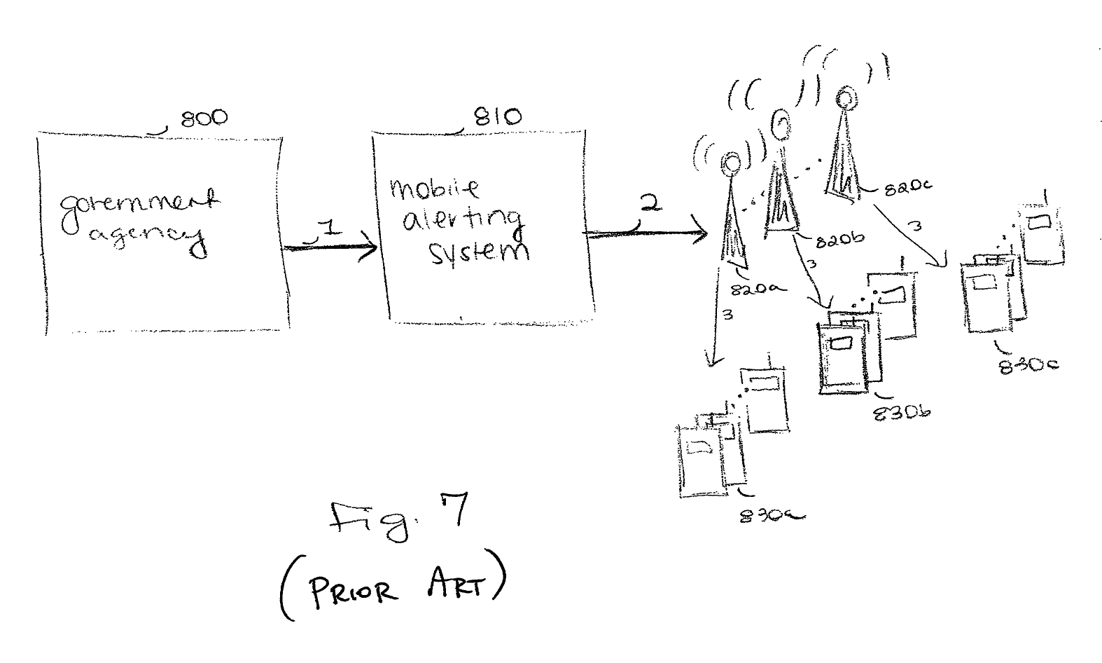

### SUMMARY OF THE INVENTION

A spatial geotargeting method to improve the accuracy of geotargeted alert delivery, comprises a geotargeting method that considers radio frequency (RF) power contours (i.e. coverage area polygons, radio frequency (RF) footprints) emitted by cell sites. Cell site emissions transcend geographic shape files and geographic political boundaries, e.g., zip codes, FIPS codes, state definitions, etc., conventionally used to define alert areas. The present invention additionally provides enhanced cell site database information for improved geotargeted alerting.

In accordance with the principles of the present invention, the inventive geotargeting method geographically targets an alert to all cell sites that have a power contour (i.e. coverage area polygon, RF footprint) that overlaps an alert area defined for the alert. Targeted cell sites receive the alert and broadcast the alert to all subscriber devices located in their coverage area.

During alert system provisioning, a known radio frequency (RF) propagation model computes RF power contours (i.e. coverage areas, RF footprints) for cell sites, given cell site attribute data obtained from a commercial mobile service provider (CMSP). Cell site attribute data (e.g. cell site ID, cell site network address, etc.) and cell site power contour data (i.e. coverage area data) is stored in a relational database.

When an alert is received on a mobile alerting system, the mobile alerting system performs a spatial query on the relational database to request records for all cell sites whose power contour intersects an alert area defined for the alert (i.e. an alert area defined via a conventional polygon shape file and/or FIPS code).

The mobile alerting system then broadcasts the alert to all cell site network addresses (e.g. IP addresses or SS7 point codes) returned in response to the spatial query. Destination cell sites receive the alert and broadcast the alert to affiliated subscriber devices.

### DETAILED DESCRIPTION OF ILLUSTRATIVE EMBODIMENTS

The present invention provides a spatial geotargeting method (i.e. a method that targets content to subscriber devices based on their physical location) that considers radio frequency (RF) power contours (i.e. coverage area polygons, radio frequency (RF) footprints) emitted by cell sites, to improve the accuracy of geotargeted alert delivery. The present invention additionally provides enhanced cell site database information for improved geotargeted alerting.

A conventional mobile alerting system (e,g, Commercial Mobile Alert System (CMAS)) is an alerting technology that allows commercial mobile service providers (CMSP) to geographically target alert messages (similar to text messages) to subscriber devices. Geotargeted alert messages alert subscribers to emergency events occurring in their area.

Alerts are conventionally formatted in accordance with a common alert protocol (CAP). A common alert protocol (CAP) is a standardized format for exchanging alert messages over alerting technologies. In accordance with the common alert protocol (CAP), every alert contains a reference to one or more alert areas, i.e., geographic areas to which alert information pertains.

An alert area is conventionally defined using a Federal Information Processing Standard (FIPS) code, e.g., a county code, a state code, etc. A conventional mobile alerting system geographically targets an alert to all cell sites located within an indicated alert area. Current practices and methods for geographically targeting alerts to subscriber devices involve a tabular lookup of cell site coordinates (e.g. lat/lon coordinates) and corresponding FIPS values.

Geotargeting granularity (i.e. a degree to which a device may be geographically targeted) in conventional mobile alerting systems is defined at the county level. A default alert area is defined using a FIPS county code.

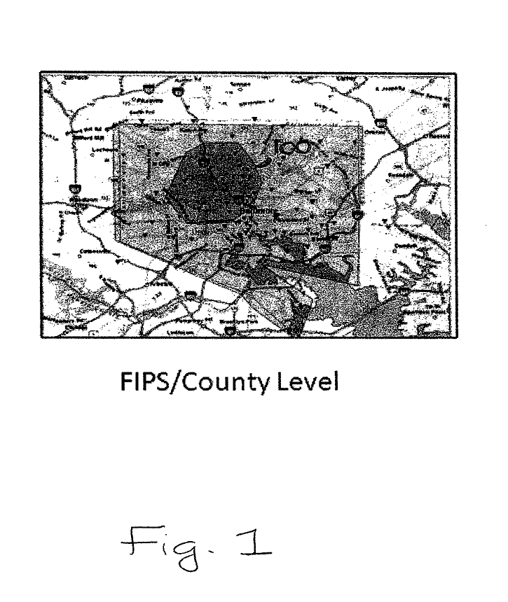

FIG. 1 depicts an exemplary alert area, as defined by a FIPS county code.

As depicted in FIG. 1, a FIPS county code defines a county wide geographic boundary 100. When an alert area is defined using a FIPS county code, a corresponding alert is broadcast to all cell sites located within that county 100.

Unfortunately, county level geotargeting is not optimal and may present various challenges depending upon the size and geography of a county 100. For example, an event that takes place in a county that spans a large geographic area (e.g. Maricopa County, AZ) may only affect a certain portion of the county's population. Hence, this implementation may confuse subscribers that receive an alert message in an unaffected area of a county. Even worse, over time, this approach may desensitize subscribers toward alerts.

To provide additional geotargeting granularity, an optional polygon shape file (i.e. X, Y shape file) may be used to define an alert area. A polygon shape file defines latitude and longitude coordinates to indicate a shape and location of an alert area. When a polygon shape file (i.e. X, Y shape file) is used to define an alert area, a point (i.e. cell site X, Y location coordinates) in polygon (shape file) method may be used to geographically target alerts.

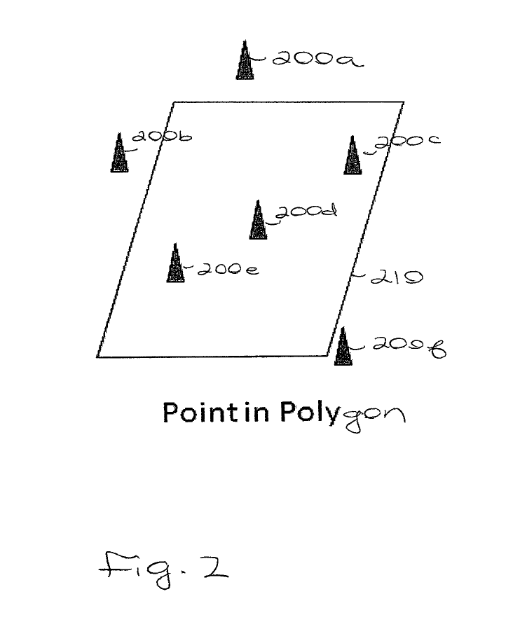

FIG. 2 depicts a point in polygon approach proposed for geotargeted alerting.

As depicted in FIG. 2, a point in polygon approach targets an alert to all cell sites 200c, 200d, 200e located inside an alert area 210 defined by a polygon shape file. An alert is not targeted to any cell sites 200a, 200b, 200f located outside the indicated alert area 210.

A polygon shape file may be used to define an alert area that transcends political boundaries, e.g., state boundaries, county boundaries, etc. However, a subscriber device located in an alert area defined by a polygon shape file will not receive an alert, if receiving service from a cell site located outside the alert area.

The present invention considers power contours (i.e. radio frequency (RF) footprints, coverage area polygons) emitted by cell sites to provide additional geotargeting granularity for geotargeted alerting. In particular, the present invention considers a geographic coverage area (i.e. a geographic area within which RF signals from a particular cell site may be received) modeled by cell site radio frequency (RF) propagation to improve the accuracy of alert delivery. Cell site emissions transcend geographic political boundaries; e.g., zip codes, FIPS codes, state definitions, etc., and geographic shape files conventionally used to define alert areas.

The inventive geotargeting method geographically targets an alert to all cell sites that have a power contour (i.e. coverage area polygon, or RF footprint) that overlaps an alert area defined for the alert.

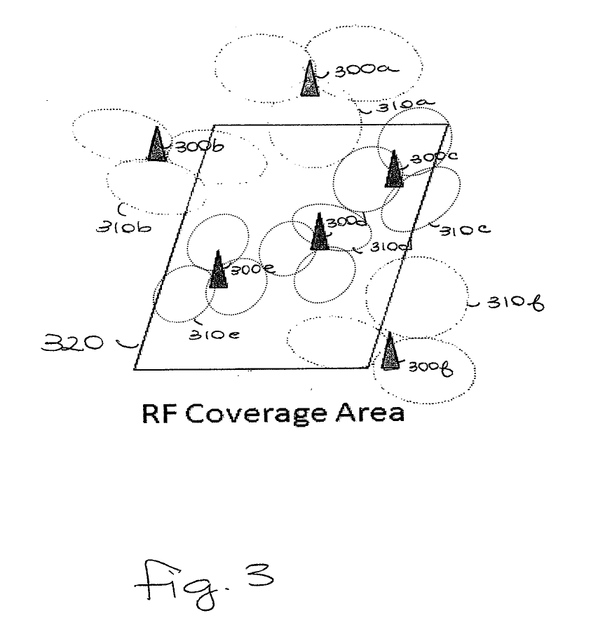

FIG. 3 depicts exemplary geographic coverage areas modeled by cell site propagation, in accordance with the principles of the present invention.

In particular, FIG. 3 depicts six cell sites 300a-300f that have power contours 310a-310f that overlap an alert area 320 defined for an alert. In accordance with the principles of the present invention, an alert is geographically targeted to all cell sites having some coverage within the alert area 320, e.g., six cell sites 300a-300f, even though only three cell sites 300c, 300d, 300e in the given example are physically located within the alert area 320.

In a conventional system the alert would be targeted only to cell sites located within an alert area, whereas in the inventive system the alert is targeted to all cell sites having at least some portion of a power contour extending into the alert area 320.

During system provisioning, cell site attribute data and cell site power contour data is compiled for geotargeted alerting based on received power levels. In particular, during system provisioning, cell site attribute data (e.g., cell site address data, cell site ID data, etc.) is compiled in to a cell site database table and subsequently input in to a known RF propagation model (wireless operators conventionally use RF propagation models as planning tools when establishing a wireless service area). The RF propagation model computes a power contour (i.e. a coverage area polygon, an RF footprint) for each cell site based on received attribute data, and stores computed power contours in a geographic shape table.

When an alert is received on a mobile alerting system, the mobile alerting system compares a polygon shape file (i.e. X, Y shape file) and/or a FIPS code indicating an alert area defined therefor, against cell site coverage areas stored in the geographic shape table. The alert is then broadcast to all cell sites with a stored power contour (i.e. coverage area polygon, RF footprint) that overlaps the defined alert area.

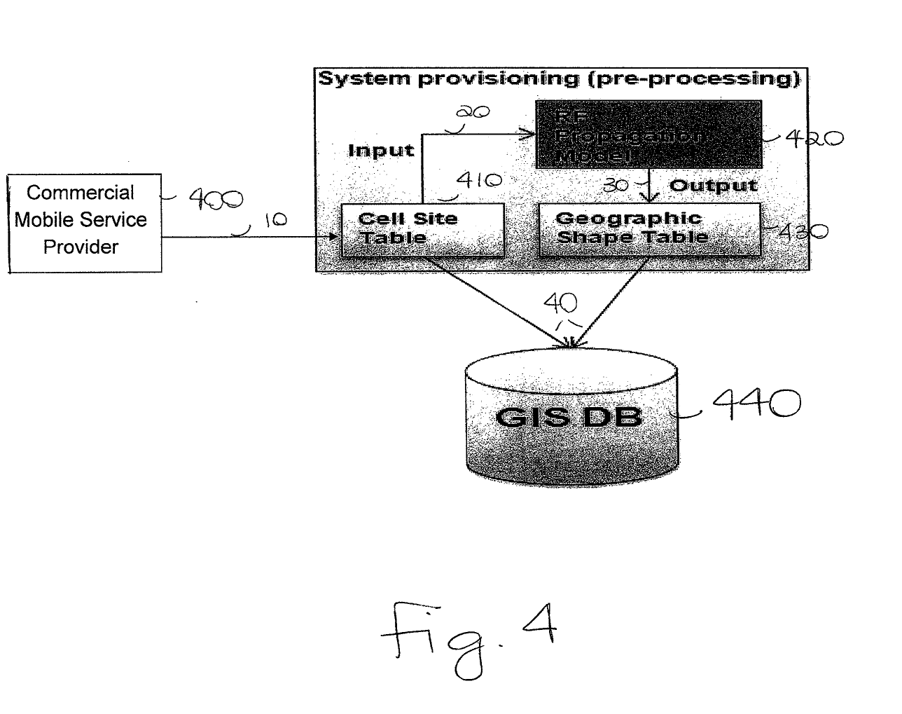

FIG. 4 depicts exemplary alert system provisioning for geotargeted alerting based on received power levels, in accordance with the principles of the present invention.

As depicted in step 10, cell site information is obtained from a commercial mobile service provider (CMSP) 400 and stored in a cell site table 410.

Table 1 depicts an exemplary cell site table 410 used to implement geotargeted alerting based on received power levels.

TABLE 1

| | Network | | | | | |
|---|---|---|---|---|---|---|
| Cell | Address of the | Site | Site | Antenna | | |
| Site | Tower (SS7 | Coordinate | Coordinate | Height | | |
| ID | point code or IP | Longitude | Latitude | Frequency | Transmitter | |
| (name) | address) | (DD) | (DD) | (m) | (MHZ) | Power (dBM) |
| Character | Character | Decimal | Decimal | Meters | Frequency | Power (Float) |
| (string) | (string) | Degrees | Degrees | (Integer) | (Float) | |
| | | (Float) | (Float) | | | |

As depicted in Table 1, each record in a cell site table 410 maintains the following information for a given cell site: a cell site ID (i.e. a name of a cell site), a network address, a latitude coordinate, a longitude coordinate, an antenna height, a frequency, and a transmitter power.

As portrayed in step 20 of FIG. 4, data from the cell site table 410 is input in to a known radio frequency (RF) propagation model (wireless carriers currently use RF propagation models to consider RF footprints when attempting to optimize cellular coverage) 420. The RF propagation model 420 uses input from the cell site table (Table 1) 410 to produce a power contour (i.e. RF power level footprint, coverage footprint) for each indicated cell site. The RF propagation model 420 creates a RF power contour by computing radiated power emissions from a known transmitter location (a known X, Y coordinate). The RF propagation model 420 is executed in an iterative fashion, corresponding to a frequency spectrum owned/licensed by an operator.

As depicted in step 30, power contours generated by the RF propagation model 420 are stored in a geographic shape table 430. Each geographic shape table 430 file includes a power contour and received power levels computed for a given cell site.

Table 2 depicts an exemplary geographic shape table 430 used to implement geotargeted alerting based on received power levels.

TABLE 2

| | Received | | X, Y contour |
|---|---|---|---|
| Cell Site ID | Power | Received Power | shape points |
| (name) | (dBM) | Contour ID | (variable length list) |
| Character | Received | Unique identifier for | A series of ordered |
| string | Signal | each received power | coordinate pairs |
| | Strength | contour produced by | containing longitude |
| | (Float) | the model output | and latitude |
| | | | coordinates stored in |
| | | | decimal degrees (Float) |

As depicted in Table 2, each record in a geographic shape table 430 maintains the following data for a given cell site: a cell site ID (i.e. a name of a cell site), a received signal strength, a unique identifier for each power contour computed for that cell site, and one or more power contour shape points (i.e. X, Y coordinates).

As shown in step 40 of FIG. 4, a geographic information system (GIS) or desktop mapping application imports cell site table 410 and geographic shape table 430 records in to a GIS relational database 440. The two tables 410 and 430 may then be related/joined using a cell site ID key, common to each. Combining the cell site table 410 and geographic shape table 430 allows cell site attribute data to be associated with cell site power contour (coverage area) data.

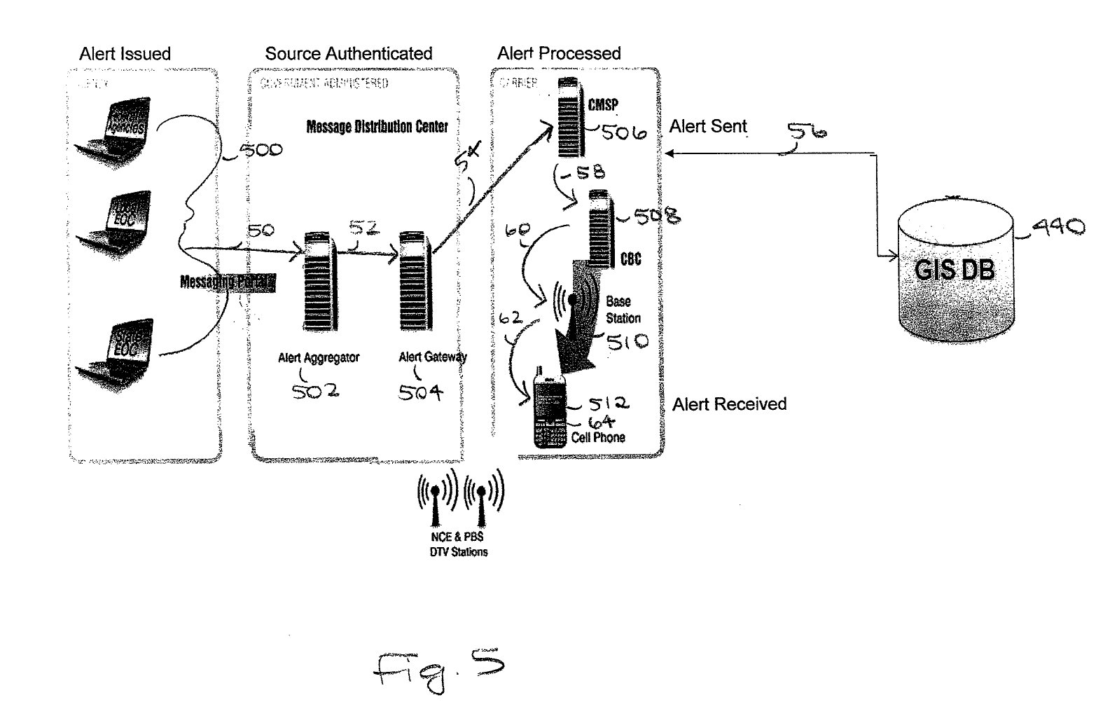

FIG. 5 depicts an exemplary process for geographically targeting an alert based on received power levels, in accordance with the principles of the present invention

As portrayed in step 50 of FIG. 5, a government agency 500 generates an alert message and passes the alert to a government administered alert aggregator 502.

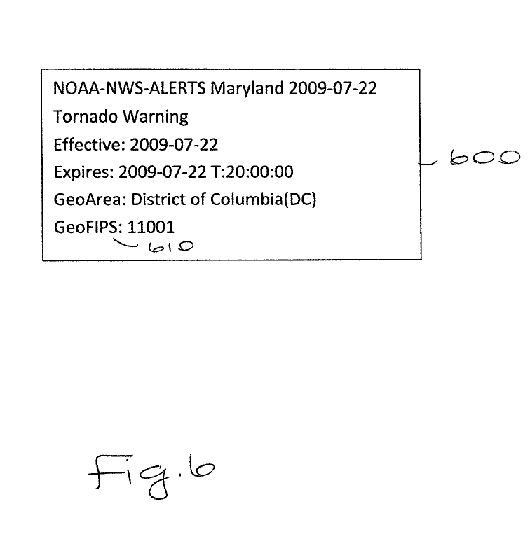

FIG. 6 depicts an illustrative alert message generated by a government agency.

As depicted in FIG. 6, each alert 600 comprises a FIPS code 610 and/or a polygon shape file (i.e. an XY shapefile), indicating an impacted or targeted alert area (e.g. a projected path of a tornado).

As shown in step 52 of FIG. 5, the alert aggregator 502 authenticates (i.e. authenticates the message source) and processes (i.e. validates the message format, reduces the message for a network carrier, converts the message in to an appropriate format, etc.) the alert 600 and then passes the alert 600 to a government administered alert gateway 504.

As depicted in step 54, the alert gateway 504 forwards the alert 600 to a mobile alerting system commercial mobile service provider (CMSP) gateway (i.e. a gateway to a wireless network) 506.

In step 56, the CMSP gateway 506 performs a spatial query (i.e. a query that requests data based on geographic parameters) on the relational database 440, to request records for all cell sites with power contours that intersect the alert area (as defined by the polygon shape file and/or FIPS code) defined for the alert. Records returned in response to the spatial query include a cell site ID attribute and a cell site network address attribute, in accompany to power contour (coverage area) data. In accordance with the principles of the present invention, the CMSP gateway 506 processes parameters received in the alert 600 and formats the alert 600 for delivery to cell sites.

As portrayed in step 58 of FIG. 5, the CMSP gateway 506 sends the alert 600 and geotargeted cell site locations to a mobile alerting system cell broadcast center (CBC) 508.

In step 60, the cell broadcast center (CBC) broadcasts the alert 600 to cell site network addresses (e.g. IP addresses or SS7 point codes) 510 indicated in the record set returned in step 56.

As depicted in step 62, the alert 600 is received at each destination cell site 510 and subsequently broadcast to affiliated subscriber devices.

In step 64, the alert 600 is received on an affiliated subscriber device 512.

Suitable RF propagation computational models, geographic information systems (GIS) technology and desktop mapping systems are all generally available off-the-shelf. Likewise the common alert protocol (CAP) format message definition referred to herein is an industry standard created and maintained by an Organization for the Advancement of Structured Information Standards (OASIS).

The present invention provides enhanced geo-targeting methods to improve the accuracy of mobile alert delivery and to provide more granular alert area notifications. Standardization of inventive geo-targeting methods and data management processes are critical to implementation. Key benefits of improved geo-targeting can be translated into an improved user experience and alert notification integrity that can ultimately save lives.

The invention has particular applicability to wireless carriers, cellular providers, commercial mobile advertisers, premium mobile content providers, enterprises, public safety, and government agencies. The present invention is also applicable to E911 call routing procedures that use cell site coverage areas to route calls to an appropriate public safety answering point (PSAP).

While the invention has been described with reference to the exemplary embodiments thereof, those skilled in the art will be able to make various modifications to the described embodiments of the invention without departing from the true spirit and scope of the invention.

What is claimed is:

1. Geotargeting an alert based on power contour of relevant cell sites, comprising:
identifying a targeted area for a given alert;
identifying all included cell sites within said targeted area;
identifying all outlying cell sites outside said targeted area but having an RF power contour covering a service area within said targeted area; and
broadcasting said given alert to all included cell sites and outlying cell sites to alert subscriber devices being serviced by said included cell sites and outlying cell sites.

2. The geotargeting an alert based on power contour of relevant cell sites according to claim 1, wherein:
said RF power contour is a radio frequency (RF) power contour.

3. The geotargeting an alert based on power contour of relevant cell sites according to claim 1, further comprising:
determing said RF power contour for a given cell site based on cell site attribute data obtained from a commercial mobile service provider (CMSP).

4. The geotargeting an alert based on power contour of relevant cell sites according to claim 1, further comprising:
provisioning cell site power contour data and cell site attribute data in a geographic information system (GIS) relational database.

5. The geotargeting an alert based on power contour of relevant cell sites according to claim 4, further comprising:
performing a spatial query on said relational database to determine said outlying cell sites.

6. The geotargeting an alert based on power contour of relevant cell sites according to claim 1, further comprising:
defining said alert area by a federal information processing standard (FIPS) code.

7. The geotargeting an alert based on power contour of relevant cell sites according to claim 1, wherein:
said alert area is defined by a polygon shape.

8. Apparatus for geotargeting an alert based on power contour of relevant cell sites, comprising:
means for identifying a targeted area for a given alert;
means for identifying all included cell sites within said targeted area;
means for identifying all outlying cell sites outside said targeted area but having an RF power contour covering a service area within said targeted area; and
means for broadcasting said given alert to all included cell sites and outlying cell sites to alert subscriber devices being serviced by said included cell sites and outlying cell sites.

9. The apparatus for geotargeting an alert based on power contour of relevant cell sites according to claim 8, wherein:
said power contour is a radio frequency (RF) power contour.

10. The apparatus for geotargeting an alert based on power contour of relevant cell sites according to claim 8, wherein:
determing said RF power contour for a given cell site based on cell site attribute data obtained from a commercial mobile service provider (CMSP).

11. The apparatus for geotargeting an alert based on power contour of relevant cell sites according to claim 8, further comprising:
means for provisioning cell site power contour data and cell site attribute data in a geographic information system (GIS) relational database.

12. The apparatus for geotargeting an alert based on power contour of relevant cell sites according to claim 11, further comprising:
means for performing a spatial query on said relational database to determine said outlying cell sites.

13. The apparatus for geotargeting an alert based on power contour of relevant cell sites according to claim 8, further comprising:
means for defining said alert area by a federal information processing standard (FIPS) code.

14. The apparatus for geotargeting an alert based on power contour of relevant cell sites according to claim 8, wherein:
said alert area is defined by a polygon shape.
